(19) United States
(12) Patent Application Publication
(10) Pub. No.: US 2021/0114173 A1
(43) Pub. Date: Apr. 22, 2021

(54) BLADE-LIKE POLISHER AND ITS MANUFACTURING METHOD

(71) Applicant: CHANGSHA EASYINSMILE INTELLIGENCE TECHNOLOGY CO,LTD, CHANGSHA (CN)

(72) Inventors: TIRAN ZHANG, CHANGSHA (CN); DAN GUO, CHANGSHA (CN)

(73) Assignee: CHANGSHA EASYINSMILE INTELLIGENCE TECHNOLOGY CO,LTD

(21) Appl. No.: 17/060,701

(22) Filed: Oct. 1, 2020

(30) Foreign Application Priority Data
Oct. 16, 2019 (CN) 201910980668.X

(51) Int. Cl. B24D 15/02; B24D 18/00; B29C 65/08; B29C 65/00

(52) U.S. Cl. CPC B24D 15/02; B24D 18/009; B29L 2031/736; B29C 66/7392; B29C 65/08

(57) ABSTRACT

This invention is ablut a blade-like polisher and its manufacturing method. Benefits of the invention include melting-resistance of weldments, low welding temperature, mitigated deformation, reduced effects of oxidized film on welding, low power consumption, easy operation, rapidity and high efficiency.

### CROSS-REFERENCE TO RELATED APPLICATIONS

This application claims priority to Chinese Patent Application No. 201910980668.X with a filing date of Oct. 16, 2019. The content of the aforementioned applications, including any intervening amendments thereto, are incorporated herein by reference.

### TECHNICAL FIELD

This invention involves a blade-like polisher and its manufacturing method, which falls into the technical field of dental products.

### BACKGROUND TECHNOLOGIES

Presently, there are the following ultrasonic welding methods: fusion welding, rivet welding, embedding and spot welding. During fusion welding, the welding head with high-frequency vibration under appropriate pressure will cause friction at the interface of two objects, which then melt and join the two objects together. During rivet welding, the vibrated welding head presses on the protruding parts of the objects and cause them to melt and take the shape of a rivet, and then the objects are riveted together securely. During embedding, the welding head under the force of pressure squeezes a metallic part into a plastic tube to a certain depth and secures it there, which works like planting the metallic part deep there. During spot welding, the objects will be welded at several spots when it is difficult to run a welding line, which will achieve similar results with fusion welding.

### DESCRIPTION OF INVENTION

This invention has provided a blade-like polisher and its manufacturing method, which overcomes shortcomings of existing technologies.

The theory of this invention is using crests of longitudinal waves to transmit vibration amplitude to the clearance between plastic objects, which after being administered a pressure, will experience molecular collision at their interface and melt down, and then become welded together.

This invention is realized through the following plan. A blade-like polisher composed of a hand-held body and a polishing band has the following characteristics: the hand-held body takes a U-shape, and both ends of the polishing band are fixed on recesses of the hand-held body.

The above U-shaped hand-held body is made of two halves, which are ultrasonically welded together. The polishing band is fixed between these two haves.

One of the two halves has a rectangular groove at either distant end of the U-shaped handle. The polishing band is mounted to grooves on both ends of the U-shaped handle. The other half has two pressing plates at corresponding positions to the grooves of the above half. The pressing plates help fix the polishing band into grooves of the polisher.

The polishing band has a through hole on either end, and there is a tapered frustum at either groove for welding purpose. The through hole and the tapered frustum form a pair and are fixed together.

The two halves are connected using a mortise and tenon joint structure, of which, one half has convex platforms, while the other half has recessed holes. There are convex platforms located at both ends and the middle of one half of the U-shaped handle, while the recessed holes are positioned at corresponding places of the other half.

On either side of the groove is mounted a piece of triangular stick for welding purpose. Either half has a piece of L-shaped triangular stick mounted between the convex platforms or recessed holes.

The manufacturing method of a blade-like polisher includes the following typical steps:

Step 1. Put the polishing band between both halves, close up the hand-held body, and put it on clamps of the ultrasonic welder.

Step 2. The signal generator of an ultrasonic welder gives off a high-frequency signal, which is converted by a transducer into electric power and high-frequency mechanic vibration acting on the hand-held body. Power of the ultrasonic welder is 1800 W, with vibration frequency of 20 Khz and amplitude of 2-3 A.

Step 3. Friction caused by vibration will raise the temperature of the tapered frustum, triangular stick and L-shaped triangular stick on surfaces of the halves and when temperature exceeds the melting point, it will cause them to melt down. Then the frustum, triangular stick and L-shaped triangular stick, after being melted down, will fill up clearance between both halves. The welding time is 0.3 second.

Step 4. Stop mechanical vibration, let it cool down under a static pressure of 3 KG for 0.2 second, and finish the welding.

Benefits of the invention include melting-resistance of weldments, low welding temperature, mitigated deformation, reduced effects of oxidized film on welding, low power consumption, easy operation, rapidity, high efficiency.

### BRIEF DESCRIPTION OF THE DRAWINGS

FIG. 1 is a structure of a blade-like polisher of the invention.

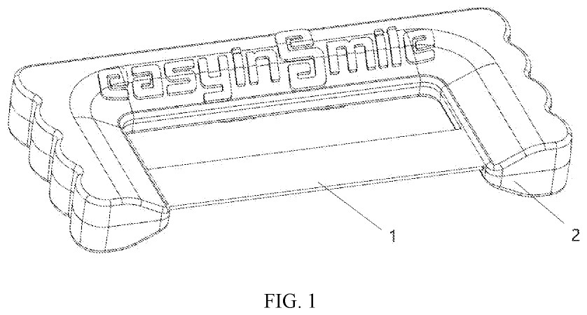

FIG. 2 is a structure of a half blade-like polisher of the invention.

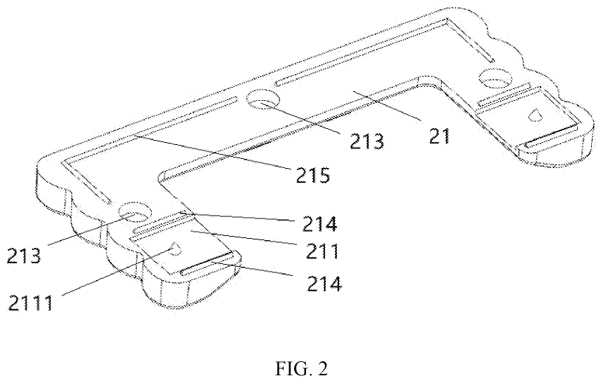

FIG. 3 is a structure of the other half blade-like polisher of the invention.

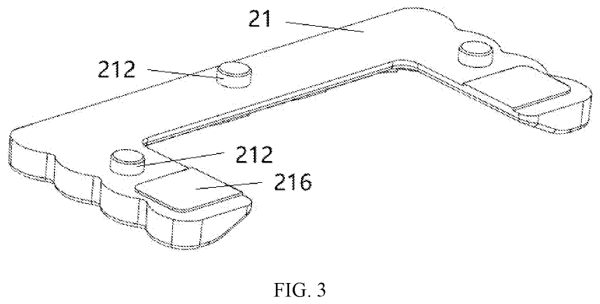

FIG. 4 is a polishing band mounting.

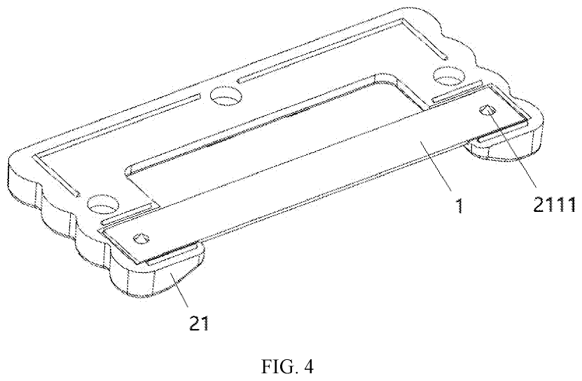

FIG. 5 is the structure of the polishing band.

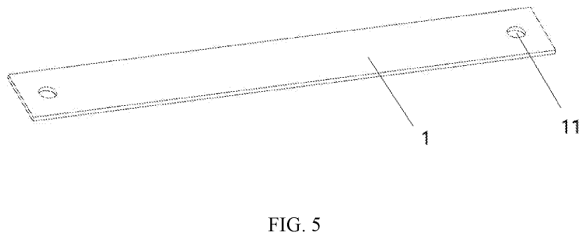

### DETAILED DESCRIPTION OF THE INVENTION

A blade-like polisher composed of a hand-held body (2) and a polishing band (1) has the following characteristics: the hand-held body (2) takes a U-shape, and both ends of the polishing band (1) are fixed on recesses of the hand-held body (2).

The above hand-held body (2) is made of two U-shaped halves (21), which are ultrasonically welded together. The polishing band (1) is fixed between these two haves (21).

One of the two halves (21) has a rectangular grooves (211) at either distant end of the U-shaped handle. The polishing band is mounted to grooves (211) on both ends of the U-shaped handle. The other half has two pressing plates (216) at corresponding positions to the grooves (211) of the above half. The pressing plates (216) help fix the polishing band (1) into grooves (211) of the polisher.

The polishing band (1) has a through hole (11) on either end, and there is a tapered frustum (2111) at either groove for welding purpose. The through hole (11) and the tapered frustum (2111) form a pair and are fixed together.

The two halves (21) are connected using a mortise and tenon joint structure, of which, one half has convex platforms (212), while the other half has recessed holes (213). There are convex platforms (212) located at both ends and the middle of one half of the U-shaped handle, while the recessed holes (213) are positioned at corresponding places of the other half.

On either side of the groove (211) is mounted a piece of triangular stick (214) for welding purpose. Either half (21) has a piece of L-shaped triangular stick (215) mounted between the convex platforms (212) or recessed holes (213).

The manufacturing method of a blade-like polisher includes the following typical steps:

Step 1. Put the polishing band (1) between both halves (21), close up the hand-held body (2), and put it on clamps of the ultrasonic welder.

Step 2. The signal generator of an ultrasonic welder gives off a high-frequency signal, which is converted by a transducer into electric power and high-frequency mechanic vibration acting on the hand-held body (2). Power of the ultrasonic welder is 1800 W, with vibration frequency of 20 Khz and amplitude of 2-3 A.

Step 3. Friction caused by vibration will raise the temperature of the tapered frustum (2111), triangular stick (214) and L-shaped triangular stick (215) on surfaces of the halves and when temperature exceeds the melting point, it will cause them to melt down. Then the frustum (2111), triangular stick (214) and L-shaped triangular stick (215), after being melted down, will fill up clearance between both halves. The welding time is 0.3 second.

Step 4. Stop mechanical vibration, let it cool down under a static pressure of 3 KG for 0.2 second, and finish the welding.

The ultrasound acting on thermoplastic contact surface will produce vibration of a high frequency of tens of thousands times per second. When a certain vibration amplitude is reached, the upper weldments will transmit the ultrasonic energy to the welding zone, where because of greater acoustic resistance at the interface of two weldments, local high temperature will be a result. Moreover, since thermal conductivity of plastic parts is low, the local high temperature cannot be reduced and will concentrate at the welding zone, as a result, contact surfaces of two plastic parts will melt down and when given a certain pressure, become welded together. When the ultrasound stops, keep pressing the plastic parts for several seconds and let it solidify, then, a strong molecular chain is formulated as a result of the welding process, whose strength is approximate to the original material. Ultrasonic welding effects of plastic parts depends on vibration amplitude of the welding head of a transducer, the pressure being administered and the welding time. The welding time and pressure on the welding head is adjustable while the vibration amplitude is decided by the transducer and the amplitude transformer. There is an optimal value during interaction of these three factors, if energy exceeds the optimal value, the plastic parts will melt excessively and become more prone to deformation, while if the energy is smaller, it is difficult to weld the plastics parts securely. Meanwhile, the pressure being administered must not be too big, the optimal value of which should be the side length of a welding zone times the optimal pressure on every 1 mm of the edge.

The blade-like polisher produced by using the structure and method of this invention has the benefits of melting-resistance of weldments, low welding temperature, mitigated deformation, reduced effects of oxidized film on welding, low power consumption, easy operation, rapidity, high efficiency.

We claim:

1. A blade-like polisher comprising: a hand-held body (2) and a polishing band (1); wherein: the hand-held body (2) is a U-shape, and both ends of the polishing band (1) are fixed on recesses of the hand-held body (2);
Wherein the above hand-held body (2) is made of two U-shaped halves (21), which are ultrasonically welded together;
wherein the polishing band (1) is fixed between these two haves (21).

2. The blade-like polisher according to claim 1, wherein,
one of the two halves (21) has a rectangular groove (211) at either distant end of the U-shaped handle;
wherein the polishing band (1) is mounted to grooves (211) on both ends of the U-shaped handle;
wherein the other half has two pressing plates (216) at corresponding positions to the grooves (211) of the above half,
wherein the pressing plates (216) help fix the polishing band (1) into grooves (211) of the polisher.

3. The blade-like polisher according to claim 1, wherein:
the polishing band (1) has a through hole (11) on both end, and there is a tapered frustum (2111) at both groove for welding purpose; the through hole (11) and the tapered frustum (2111) form a pair and are fixed together.

4. The blade-like polisher according to right claim 1, wherein:
the two halves (21) are connected using a mortise and tenon joint structure; one half has convex platforms (212), while the other half has recessed holes (213);
wherein there are convex platforms (212) located at both ends and the middle of one half of the U-shaped handle; wherein the recessed holes (213) are positioned at corresponding places of the other half.

5. The blade-like polisher according to claim 4, wherein:
on each side of the groove (211) is mounted a piece of triangular stick (214) for welding; each half (21) has a piece of L-shaped triangular stick (215) mounted between the convex platforms (212) or recessed holes (213).

6. A manufacturing method a blade-like polisher according to claim 1 comprising steps:
(Step 1) put the polishing band (1) between both halves (21), close up the hand-held body (2), and put it on clamps of the ultrasonic welder;
(Step 2) the signal generator of an ultrasonic welder gives off a high-frequency signal, which is converted by a transducer into electric power and high-frequency mechanic vibration acting on the hand-held body (2); power of the ultrasonic welder is 1800 W, with vibration frequency of 20 Khz and amplitude of 2-3 A.
(Step 3) friction caused by vibration will raise the temperature of the tapered frustum (2111), triangular stick (214) and L-shaped triangular stick (215) on surfaces of the halves and when temperature exceeds the melting point, it will cause them to melt down; then the frustum (2111), triangular stick (214) and L-shaped triangular stick (215), after being melted down, will fill up clearance between both halves; the welding time is 0.3 second;
(Step 4) stop mechanical vibration, let it cool down under a static pressure of 3 KG for 0.2 second, and finish the welding.
